(19) United States
(12) Patent Application Publication
(10) Pub. No.: US 2024/0426524 A1
(43) Pub. Date: Dec. 26, 2024

(54) EXHAUST GAS TREATMENTAPPARATUS

(71) Applicant: CRYO H&I, INC, Pyeongtaek-si (KR)

(72) Inventors: Won Kyun YANG, Yongin-si (KR); Kyung Joon AHN, Hwaseong-si (KR)

(21) Appl. No.: 18/826,608

(22) Filed: Sep. 6, 2024

Related U.S. Application Data
(63) Continuation of application No. PCT/KR2023/003144, filed on Mar. 8, 2023.

(30) Foreign Application Priority Data
Mar. 8, 2022 (KR) 10-2022-0029569

(51) Int. Cl. F25B 9/10; B01D 53/00; B01D 53/14; B01D 53/18

(52) U.S. Cl. CPC F25B 9/10; B01D 53/002; B01D 53/1431; B01D 53/18; B01D 2257/102; B01D 2257/104; B01D 2257/504; B01D 2257/80; B01D 2258/0216

(57) ABSTRACT

An exhaust gas treatment device for treating an exhaust gas emitted from a processing device by using a plurality of cryocoolers includes a preprocessor configured to cool the exhaust gas emitted from a pump provided within the processing device by using the plurality of cryocoolers and generate a plurality of groups of condensed exhaust gases and a purifier including a plurality of scrubbers configured to purify the plurality of groups of condensed exhaust gases, respectively.

### TECHNICAL FIELD

The present disclosure relates to an exhaust gas treatment device configured to treat an exhaust gas emitted from a processing device by using a plurality of cryocoolers.

### BACKGROUND

The term “carbon neutrality” refers to achieving net-zero carbon dioxide emissions by balancing the amount of carbon dioxide emissions produced from businesses or individuals with an equivalent amount of carbon dioxide removals. In other words, it means implementing measures to absorb enough carbon dioxide to offset the amount of carbon dioxide released into the atmosphere so that the total amount of carbon dioxide can be zero.

Recently, major countries have announced that they will gradually phase out the use of fossil fuels to achieve carbon neutrality. However, due to significant practical challenges of discontinuing the use of fossil fuels, research on carbon dioxide capture and treatment is actively being conducted to enable global greenhouse gas reductions while continuing to use fossil fuels.

Regarding the carbon dioxide capture and treatment technology, Korean Patent Laid-open Publication No. 2009-0129511 discloses capture of carbon dioxide from air.

However, in the case of the conventional carbon dioxide capture and treatment technology, it is applied to all air containing carbon dioxide, which results in low efficiency and an increase in size of a capture device.

### DISCLOSURE OF THE INVENTION

### Problems to be Solved by the Invention

The present disclosure is conceived to provide an exhaust gas treatment device, including: a preprocessor configured to cool an exhaust gas emitted from a pump within a processing device by using a plurality of cryocoolers and generate a plurality of groups of condensed exhaust gases; and a purifier including a plurality of scrubbers configured to purify the plurality of groups of condensed exhaust gases, respectively.

The problems to be solved by the present disclosure are not limited to the above-described problems. There may be other problems to be solved by the present disclosure.

### Means for Solving the Problems

According to an aspect of the present disclosure, an exhaust gas treatment device includes a preprocessor configured to cool the exhaust gas emitted from a pump provided within the processing device by using the plurality of cryocoolers and generate a plurality of groups of condensed exhaust gases and a purifier including a plurality of scrubbers configured to purify the plurality of groups of condensed exhaust gases, respectively.

According to an embodiment of the present disclosure, the preprocessor includes a first cooling tank including a first cryocooler configured to cool the exhaust gas to a first temperature and generate a first group of condensed exhaust gases and a second cooling tank including a second cryocooler configured to cool the exhaust gas to a second temperature lower than the first temperature and generate a second group of condensed exhaust gases.

According to an embodiment of the present disclosure, the purifier includes a wet scrubber configured to treat the first group of condensed exhaust gases by a wet method and a combustion scrubber configured to treat the second group of condensed exhaust gases by combustion

According to an embodiment of the present disclosure, the preprocessor further includes a third cooling tank including a third cryocooler configured to cool the exhaust gas to a third temperature lower than the second temperature and generate a third group of condensed exhaust gases.

According to an embodiment of the present disclosure, the purifier further includes a plasma type scrubber configured to treat the third group of condensed exhaust gases with plasma.

According to an embodiment of the present disclosure, the plurality of cryocoolers is connected in series in order to allow the exhaust gas to sequentially pass through the plurality of cryocoolers.

According to an embodiment of the present disclosure, each of the plurality of cryocoolers is connected to one of the plurality of scrubbers.

According to an embodiment of the present disclosure, the purifier further includes an inhaler configured to inhale each of the plurality of groups of condensed exhaust gases toward the purifier.

According to an embodiment of the present disclosure, the purifier further includes a plurality of gas tanks configured to liquefy the plurality of groups of condensed exhaust gases, respectively.

### Effects of the Invention

According to any one of the above-described means for solving the problems of the present disclosure, it is possible to provide an exhaust gas treatment device configured to cool an exhaust gas emitted from a pump within a processing device by using a plurality of cryocoolers and generate a plurality of groups of condensed exhaust gases from nitrogen, oxygen, moisture, carbon dioxide, etc. contained in air.

Also, it is possible to provide an exhaust gas treatment device configured to treat an exhaust gas by using a plurality of scrubbers to purify the plurality of groups of condensed exhaust gases, respectively.

### BRIEF DESCRIPTION OF THE DRAWINGS

FIG. 1 is a configuration view of an exhaust gas system according to an embodiment of the present disclosure.

FIG. 2 illustrates an example of treating an exhaust gas in an exhaust gas treatment device according to an embodiment of the present disclosure.

### BEST MODE FOR CARRYING OUT THE INVENTION

Hereinafter, embodiments of the present disclosure will be described in detail with reference to the accompanying drawings so that the present disclosure may be readily implemented by a person with ordinary skill in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Further, through the whole document, the term “connected to” or “coupled to” that is used to designate a connection or coupling of one element to another element includes both a case that an element is “directly connected or coupled to” another element and a case that an element is “electronically connected or coupled to” another element via still another element. Furthermore, the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “unit” includes a unit implemented by hardware, a unit implemented by software, and a unit implemented by both of them. One unit may be implemented by two or more pieces of hardware, and two or more units may be implemented by one piece of hardware.

Through the whole document, a part of an operation or function described as being carried out by a terminal or device may be carried out by a server connected to the terminal or device. Likewise, a part of an operation or function described as being carried out by a server may be carried out by a terminal or device connected to the server.

Hereinafter, the present disclosure will be explained in detail with reference to the accompanying configuration views or process flowcharts.

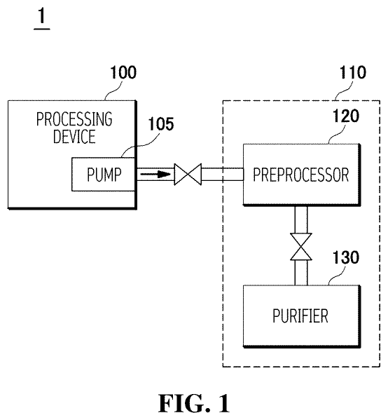

FIG. 1 is a configuration view of an exhaust gas system according to an embodiment of the present disclosure. Referring to FIG. 1, an exhaust gas system 1 may include a processing device 100 and an exhaust gas treatment device 110.

The processing device 100 may be, for example, a semiconductor manufacturing device. Also, the processing device 100 may be equipped with, for example, a space for processing a substrate, an support capable of supporting the substrate, and a gas supply unit for supplying various gases to be used for treating the substrate.

The processing device 100 may generate an exhaust gas during a semiconductor manufacturing process.

A pump 105 is provided in an exhaust line within the processing device 100, and may be configured to collect the exhaust gas generated by the processing device 100 and emit the exhaust gas to the exhaust gas treatment device 110 through the exhaust line.

The exhaust gas treatment device 110 is connected to the processing device 100 through the exhaust line and thus may be supplied with the exhaust gas emitted from the pump 105 provided within the processing device 100. Also, the exhaust gas treatment device 110 may treat the exhaust gas emitted from the processing device 100 with a plurality of cryocoolers.

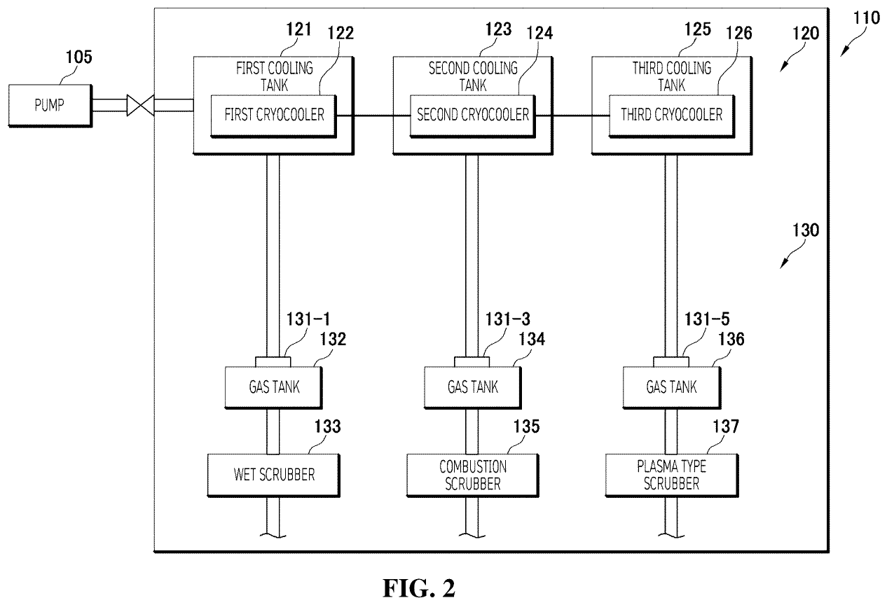

The exhaust gas treatment device 110 may include a preprocessor 120 and a purifier 130. The components of the exhaust gas treatment device 110 will be described in detail with reference to FIG. 2.

The preprocessor 120 may cool an exhaust gas emitted from the pump 105 provided within the processing device 100 by using the plurality of cryocoolers and generate a plurality of groups of condensed exhaust gases. Herein, the exhaust gas emitted from the pump 105 provided within the processing device 100 may be air containing, for example, nitrogen, oxygen, moisture, carbon dioxide, etc.

The purifier 130 may include a plurality of scrubbers configured to purify the plurality of groups of condensed exhaust gases, respectively. For example, the purifier 130 may purify the condensed exhaust gases, such as moisture, carbon dioxide, nitrogen, oxygen, etc., by using the plurality of scrubbers.

Hereinafter, a process of treating an exhaust gas, which is emitted from the processing device, in the exhaust gas treatment device 110 will be described with reference to FIG. 2.

FIG. 2 illustrates an example of treating an exhaust gas in an exhaust gas treatment device according to an embodiment of the present disclosure. Referring to FIG. 2, the preprocessor 120 may include a first cooling tank 121, a second cooling tank 123, and a third cooling tank 125. Herein, each of the first cooling tank 121, the second cooling tank 123, and the third cooling tank 125 may include a cryocooler including at least one of a first state and a second stage.

The first cooling tank 121 may include a first cryocooler 122 configured to cool the exhaust gas to a first temperature and generate a first group of condensed exhaust gases.

The second cooling tank 123 may include a second cryocooler 124 configured to cool the exhaust gas to a second temperature lower than the first temperature and generate a second group of condensed exhaust gases.

The third cooling tank 125 may include a third cryocooler 126 configured to cool the exhaust gas to a third temperature lower than the second temperature and generate a third group of condensed exhaust gases. For example, it is assumed that the exhaust gas contains moisture, nitrogen, oxygen, carbon dioxide, etc. Herein, the exhaust gas treatment device 110 may generate each group of condensed exhaust gases in consideration of the freezing points of moisture, carbon dioxide, nitrogen, and oxygen, respectively, contained in the exhaust gas.

For example, the first cooling tank 121 may cool the exhaust gas to the first temperature of, for example, 0° C. by using the first cryocooler 122 and generate the first group of condensed exhaust gases of moisture. To this end, the first cryocooler 122 may be a cryocooler including the first stage only.

The second cooling tank 123 may cool the exhaust gas to the second temperature of, for example, −80° C. by using the second cryocooler 124 and generate the second group of condensed exhaust gases of carbon dioxide. To this end, the second cryocooler 124 may be a cryocooler including the first stage only.

the third cooling tank 125 may cool the exhaust gas to the third temperature of, for example, −253° C. by using the third cryocooler 126 and generate the third group of condensed exhaust gases of nitrogen and oxygen. To this end, the third cryocooler 126 may be a cryocooler including the first stage and the second stage.

The groups of condensed exhaust gases generated by using the cryocoolers included in the plurality of cooling tanks, respectively, may be different from each other depending on the type of gas contained in the exhaust gas (due to different freezing points of gases), but the present disclosure is not limited thereto.

The plurality of cryocoolers 122, 124 and 126 may be connected in series in order to allow the exhaust gas to sequentially pass through the plurality of cryocoolers 122, 124 and 126. Also, each of the plurality of cooling tanks 121, 123 and 125 may be connected to one of the plurality of scrubbers 133, 135 and 137 included in the purifier 130.

The purifier 130 may include inhalers 131-1, 131-3 and 131-5, a plurality of gas tanks 132, 134 and 136, and the plurality of scrubbers 133, 135 and 137.

The inhalers 131-1, 131-3 and 131-5 may inhale the plurality of groups of condensed exhaust gases, respectively, toward the purifier 130. The inhaler 131 may include, for example, a first inhaler 131-1, a second inhaler 131-3, and a third inhaler 131-5. For example, the first inhaler 131-1 may inhale the first group of condensed exhaust gases from the first cooling tank 121, the second inhaler 131-3 may inhale the second group of condensed exhaust gases from the second cooling tank 123, and the third inhaler 131-5 may inhale the third group of condensed exhaust gases from the third cooling tank 125.

The plurality of gas tanks 132, 134 and 136 may liquefies the plurality of groups of condensed exhaust gases, respectively. For example, the plurality of gas tanks 132, 134 and 136 may be include a heater for liquefying each group of condensed exhaust gases.

The plurality of scrubbers 133, 135 and 137 may include a wet scrubber 133, a combustion scrubber 135, and a plasma type scrubber 137.

The wet scrubber 133 may treat the first group of condensed exhaust gases by a wet method. For example, the wet scrubber 133 may neutralize or absorb the first group of condensed exhaust gases by bringing the first group of condensed exhaust gases into contact with a cleaning liquid.

The combustion scrubber 135 may treat the second group of condensed exhaust gases by combustion. The combustion scrubber 135 may treat a hybrid gas and perfluorocarbon (PFC) by injecting a liquefied natural gas (LNG) and air to combust condensed exhaust gases at a sufficiently high temperature (e.g., 1200° C.).

The plasma type scrubber 137 may treat the third group of condensed exhaust gases with plasma. The plasma type scrubber 137 is used to clean PFC, and a low-temperature plasma type scrubber is configured to discharge low-voltage power and decompose a harmful gas by allowing the harmful gas to pass through therebetween, and a high-temperature plasma type scrubber is configured to cause continuous discharge by using high-voltage DC power and decompose a target gas by allowing the target gas to pass through therebetween.

The exhaust gas treatment device 110 may cool the exhaust gas to the first temperature of 0° C. by using the first cryocooler 122 of the first cooling tank 121 and generate condensed exhaust gases of moisture, and treat moisture 300 by using the wet scrubber 133 by a wet method. Herein, the moisture 300 is frozen at 0° C. and thus can be removed by the wet scrubber.

Also, the exhaust gas treatment device 110 may cool the exhaust gas to the second temperature of −80° C., which is lower than the first temperature of 0° C., by using the second cryocooler 124 of the second cooling tank 123 and generate condensed exhaust gases of carbon dioxide, and capture carbon dioxide by using the wet scrubber 133. Herein, carbon dioxide 310 is frozen at −80° C. and thus can be captured. Alternatively, carbon dioxide may be captured by the combustion scrubber 135.

That is, according to the present disclosure, the exhaust gas treatment device 110 may perform treatments of the respective groups of condensed exhaust gases in parallel by using the plurality of scrubbers.

Through the above-described process, the exhaust gas treatment device 110 may sort gases, such as nitrogen, oxygen, carbon dioxide, etc., contained in an exhaust gas according to different freezing points of the gases through temperature control by using a plurality of cryocoolers, and treat the gases by using respective scrubbers.

A conventional exhaust gas treatment device treats moisture, nitrogen, oxygen, carbon dioxide, etc. contained in an exhaust gas by using a single scrubber (a wet scrubber, a combustion scrubber, or a plasma type scrubber). Thus, the exhaust gas is not completely treated.

However, according to the present disclosure, it is possible to sort gases and treat the gases by using scrubbers suitable for the respective gases. Thus, it is possible to more completely treat an exhaust gas.

Also, according to the present disclosure, the exhaust gas treatment device 110 may capture carbon dioxide only as needed, or may remove the moisture 300 and the carbon dioxide 310 to emit nitrogen and oxygen only.

The above description of the present disclosure is provided for the purpose of illustration, and it would be understood by a person with ordinary skill in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. An exhaust gas treatment device for treating an exhaust gas emitted from a processing device by using a plurality of cryocoolers, comprising:
a preprocessor configured to cool the exhaust gas emitted from a pump provided within the processing device by using the plurality of cryocoolers and generate a plurality of groups of condensed exhaust gases; and
a purifier including a plurality of scrubbers configured to purify the plurality of groups of condensed exhaust gases, respectively.

2. The exhaust gas treatment device of claim 1,
wherein the preprocessor includes:
a first cooling tank including a first cryocooler configured to cool the exhaust gas to a first temperature and generate a first group of condensed exhaust gases; and
a second cooling tank including a second cryocooler configured to cool the exhaust gas to a second temperature lower than the first temperature and generate a second group of condensed exhaust gases.

3. The exhaust gas treatment device of claim 2,
wherein the purifier includes:
a wet scrubber configured to treat the first group of condensed exhaust gases by a wet method; and
a combustion scrubber configured to treat the second group of condensed exhaust gases by combustion.

4. The exhaust gas treatment device of claim 3,
wherein the preprocessor further includes:
a third cooling tank including a third cryocooler configured to cool the exhaust gas to a third temperature lower than the second temperature and generate a third group of condensed exhaust gases.

5. The exhaust gas treatment device of claim 4,
wherein the purifier further includes:
a plasma type scrubber configured to treat the third group of condensed exhaust gases with plasma.

6. The exhaust gas treatment device of claim 1,
wherein the plurality of cryocoolers is connected in series in order to allow the exhaust gas to sequentially pass through the plurality of cryocoolers.

7. The exhaust gas treatment device of claim 6,
wherein each of the plurality of cryocoolers is connected to one of the plurality of scrubbers.

8. The exhaust gas treatment device of claim 1,
wherein the purifier further includes:
an inhaler configured to inhale each of the plurality of groups of condensed exhaust gases toward the purifier.

9. The exhaust gas treatment device of claim 1,
wherein the purifier further includes:
a plurality of gas tanks configured to liquefy the plurality of groups of condensed exhaust gases, respectively.
